(19) United States
(12) Patent Application Publication
(10) Pub. No.: US 2022/0034521 A1
(43) Pub. Date: Feb. 3, 2022

(54) NOVEL METHOD OF USING STORED SOLAR HEAT FOR WATER HEATING

(71) Applicant: Dipak R. Biswas, Northborough, MA (US)

(72) Inventor: Dipak R. Biswas, Northborough, MA (US)

(21) Appl. No.: 16/941,744

(22) Filed: Jul. 29, 2020

(51) Int. Cl. F24D 11/00; F24S 23/30; F24S 60/10; F24S 80/52; F24H 7/04; F24S 23/71; H02S 40/32; H02S 40/44

(52) U.S. Cl. CPC F24D 11/007; F24S 23/31; F24S 23/30; F24S 60/10; F24S 80/52; F24S 2080/011; F24D 11/008; F24S 23/71; H02S 40/32; H02S 40/44; F24H 7/0425

(57) ABSTRACT

A novel method is described for room heating using stored solar heat. Solar heat is stored in an insulated tank by using scrap and inexpensive heat absorbing or heat storing materials. Stored heat can then be extracted by air circulation for room heating. The temperature of the room air is controlled by a thermostat. When the room temperature drops below the set point on the thermostat, a circulating air pump turns on and extract the solar heat until the room temperature air reaches the desired set temperature. Once room temperature reaches the set point in the thermostat, the air circulation pump turns off.

### BACKGROUND OF THE INVENTION

The present invention is in the field of room or space heating by a novel method using stored solar heat. More particularly, the present invention uses heat storing materials that absorb solar heat using reusable, inexpensive available materials along with a backup heating method when solar radiation is not sufficiently available.

Room heating is commonly done by using forced hot air, forced hot water, boiler and radiator, baseboard heater, electrical heater, etc. Using available sunrays, room heating can be accomplished by using stored solar heat. Since the sun doesn't shine all the time, storage of solar heat is very useful for later use when there is a demand for room heating. The present invention showed a novel method of storing solar heat for a long period of time and can be used later to heat the room air. Additionally, when the solar rays are not sufficiently available, an auxiliary heating system will generate enough heat for heating the house.

### SUMMARY OF THE INVENTION

In accordance with one embodiment of the invention, the present invention relates to a method of storing solar heat in an insulated tank and heating up the room air using the stored solar heat. Solar heat can be stored in the insulated tank by using scrap and inexpensive abundantly available heat absorbing or heat storing materials. The stored heat can then be used to heat the room air by air circulation. Most homes are heated by using forced hot air using a thermostat. When the home temperature drops below the set point on the thermostat, circulating air pump turns on and pump the hot air until it reaches the desired set temperature. Once it reaches the set point in the thermostat air circulation pump turns off.

### BRIEF DESCRIPTION OF DRAWINGS

Above-mentioned and other features and objectives of this invention will become more apparent by reference to the following description taken in conjunction with the accompanying drawing, in which:

FIG. 1. is a schematic view of the solar air heating system with a reflective mirror and an auxiliary backup electrical heating system;

FIG. 2. is a schematic view of the solar air heating system with a parabolic mirror and an auxiliary backup electrical heating system;

FIG. 3. is a schematic view of the back-up heating system using a resistance heating coil which is placed inside a Quartz Tube for a backup electrical heating; and

FIG. 4. is a view of a path of the sun through the sky.

### DETAIL DESCRIPTION OF THE PREFERRED EMBODIMENTS

Typically concentrated solar power (CSP) uses solar rays to concentrate using mirrors and reflectors for generating electricity by using high heat generated by the CSP. The generated heat heats up molten salt to nearly 1050 F and can be used for generating steam. This steam can drive a steam turbine to generate large amount of electricity (1). In stead of generating large amount of electricity from the CSP, the present invention uses the concentrated solar rays to store heat for room or space air heating using scrap and inexpensive abundantly available heat absorbing or heat storing materials.

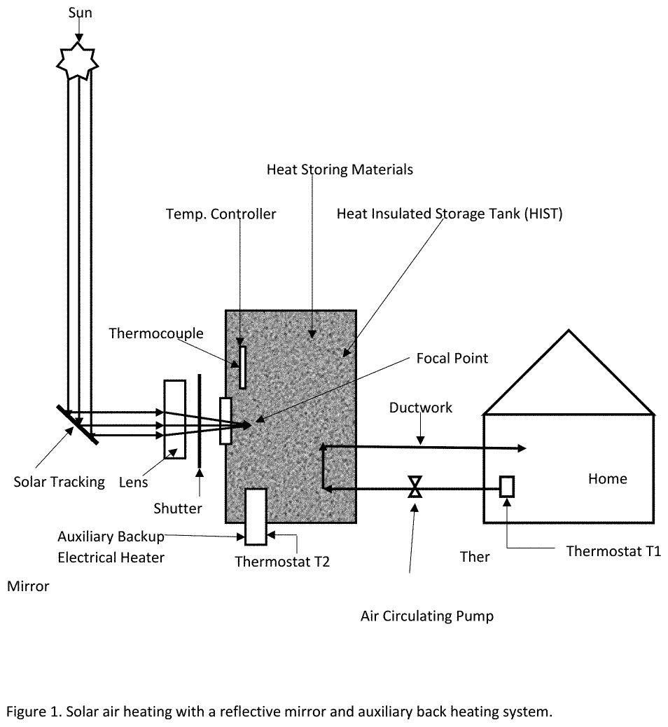

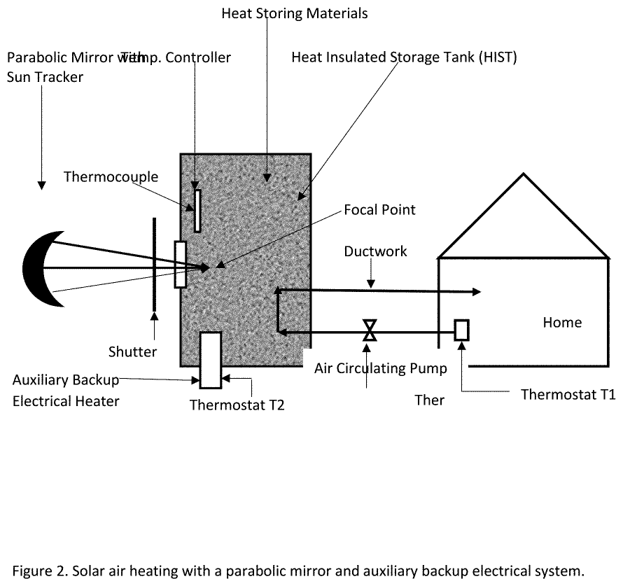

Sunrays are reflected from a mirror and directed through a lens (convex, Fresnel) or a parabolic mirror or a magnifying glass for concentrating incident solar rays into a heat insulted storage tank (HIST). High temperature resistant ceramic fiber blanket is used to insulate the storage tank. Ceramic blankets can withstand temperature in excess of 1800 F. Commercial manufactures, such as: Unitherm International, Unifrax, Thermaxx, Morgan Advanced materials supply thermal insulation product which can be used in the HIST. When a mirror is used, reflected rays pass through a quartz window and concentrated at the focal point by using a lens as shown in FIG. 1. When a parabolic mirror is used, the incident solar rays also passes through a quartz window and are concentrated at a focal point as shown in FIG. 2. An intense heat is generated at the focal point. In the heat absorbing tank, heat absorbing or heat storing materials such as: sand, stone, rocks, bricks, concrete, marble, scrap steel and iron are used to store heat because of their low specific heat which is a measure of their heat capacity as shown in Table 1.

TABLE 1
Specific heat of some common materials

| Materials | Specific Heat, J/Kg C. |
|---|---|
| Water | 4182 |
| Sand | 830 |
| Stone | 920 |
| Steel | 490 |
| Iron | 450 |

Sand, steel and iron have a much lower specific heat than water and that's why sand gets hotter faster than water. Also rocks and stones are commonly used in sauna to store heat as they absorb heat, store and release that heat with time.

Some of the heat conducting materials such as: scrap aluminum, iron and copper plates, rods or filings are also placed inside the insulated tank. They are used for conducting the heat from the focal point of the solar rays to the surrounding heat absorbing materials inside the insulating tank for achieving a steady state temperature.

Thermal conductivity is a measure of material's ability for allowing heat to conduct. Denser material such as metals are good conductors whereas less dense materials and gases are poor conductor (called insulators). Thermal conductivity of selected materials is shown in Table 2.

TABLE 2
Thermal conductivity of selected materials

| Materials | Thermal conductivity, W/(m K) |
|---|---|
| Aluminum | 220-240 |
| Copper | 350-400 |
| Silver | 350-425 |
| Iron | 50-80 |
| Water | 0.06 |

The ideal heat storing or heat absorbing material should be dense and heavy so that it can absorb and retain significant amounts of heat. Scrap stainless steel, iron, sand, stone, concrete and marble are suitable for this purpose. They are abundantly available and inexpensive. Metallic material such as steel can retain or store heat as it remains hot for the longest period of time.

As the sun rays are focused either through a lens (light concentrator) and pass through a quartz window, or through a parabolic mirror and pass through a quartz window, intense heat is generated at the focal point. Intense heat is then transferred to the surrounding area using heat conducting materials such as scrap aluminum, and copper. Aluminum or copper can be in the form of plates, rods or filings. As concentrated solar rays at the focal point generate heat (as high as 500 to 600 C, referenced in 2-4), this heat is conducted through scrap aluminum or copper to the heat absorbing materials and stores the heat. When the steady state temperature in the heat absorber tank reaches say 500 F, room temperature air is circulated into the insulated HIST. The heated air is then passes through a duct to room as shown in FIGS. 1 and 2. When the room air temperature reaches the required set temperature of typically 68 to 70 F, thermostat T1 will shut off the air circulating pump. When the air temperature falls below the set point of say 68 F, the thermostat (T1) will turn on the air circulating pump automatically and the hot air will flow into the room.

In order to control the temperature inside the solar HIST, a thermocouple (TC), such as Type-K, (5) with a temperature range of −328 to 2282° F. is placed inside the heat absorbing materials and it is connected to a digital controller, such as: Omega CN 740 series (6). Type K thermocouple is connected to one side of the temperature controller CN 740 and the lens shutter (S) is connected to the other side of the same controller. When the set point temperature say 500 F is reached, the controller shuts off the shutter so that reflected rays cannot go to the insulated heat absorbing tank (FIGS. 1 and 2). When the HIST temperature goes below the set point of say 500 F, the temperature controller turns on and the shutter opens up so that the sunrays can go through the quartz window and focus inside the insulating HIST chamber. Heat generated at the focal point is then absorbed by the heat absorbing materials. The process continues till the set temperature of say 500 F is reached.

When the room air temperature falls below the set point say 68 F, thermostat (T1) turns on the air circulating pump and the air circulator starts to flow the room air and extracts the heat and flows back to the room till temperature to reach 68 F, then the thermostat shuts off.

The mirror, parabolic mirror, shutter and quartz window (in FIGS. 1 and 2) can be protected from atmospheric conditions by using an enclosure to prevent wind, rain, snow, dust like atmospheric changes.

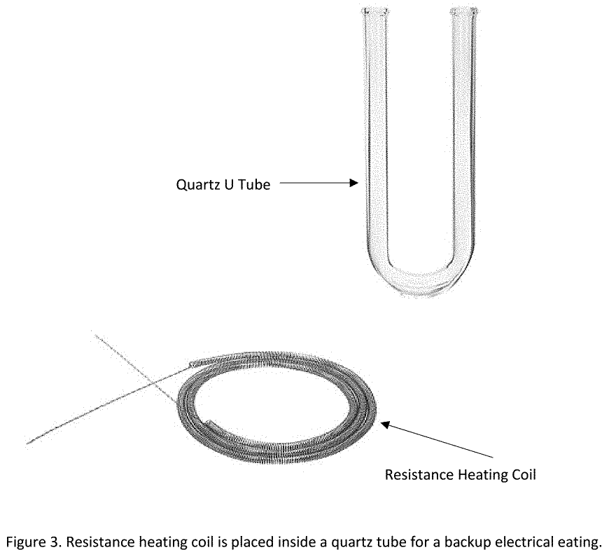

Even though solar energy can be collected during overcast or rainy days, its efficiency drops down significantly. On overcast or snowy days or when there are not enough solar rays available, there is an auxiliary back up heating system placed inside the HAT as shown in FIGS. 1 and 2. It consists of an electrical resistance heating assembly (FIG. 3) using a resistance heating coil placed inside a quartz tube. It is placed in the heat absorbing material inside the solar HIST. Heating coil can be made of nichrome wire or others. Nichrome wires can heat up to 2100 F. One of the advantages of nichrome is that it is resistant to heat and oxidation. Heating coil assembly consists of a nichrome wire inside a quartz tube and is connected to a standard electrical outlet or it can be connected to a solar powered photovoltaic (PV) systems (a combination of solar panels, inverter, other electrical and mechanical hardware). On a sunny or overcast day, photovoltaic solar cells produce electricity and it is connected to the electrical grid. The heating assembly is also connected to a thermostat (T2). When the solar HIST temperature drops below the set point of 500 F on overcast or snowy day, the auxiliary heating system turns on automatically by the thermostat T2 and continues till the HIST temperature reaches 500 F. At this point the thermostat T2 will turn off. When the room air falls below the set point of 68 F, the thermostat (T1) will turn on the air circulating pump automatically, collect the heat from HIST and circulates to home. When the room air temperature reaches the required set temperature of 68 F, thermostat T1 will shut off the air circulator.

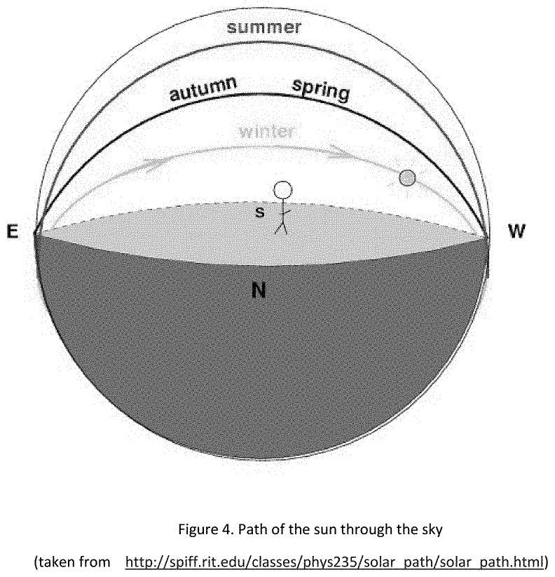

A solar ray reflecting mirror or a parabolic mirror needs to track the path of the sun and keep its incoming rays focused at the focal point during the day (FIG. 4) in order to capture sunrays most of the day. Many solar tracking systems are commercially available. Most of them are used to track the sun for operating relatively large solar panels and they are expensive. A 4 kW solar panel tracking system costs between $1400 to $2200 (7).

In the present invention, a solar tracking system is used to track a mirror or a parabolic mirror which is smaller in size and less expensive, ranges from $147 to $569 (8-10). There are several newly developed products are commercially available.

Example 1. One such solar tracking product is Sun World's Sun Tracker (ST-600 Sun Tracker) (8). It is a single axis device that will follow the track of the sun from sunrise to sunset. This tracker is powered by using small solar panels. It is a self powered and self aligning design made by Solar Made (Patent pending).

Example 2. Another solar tracking product made by Eco-Worthy (9) is a dual axis solar tracking linear actuator controller complete electronic system—dual axis solar tracker kit with linear actuators, 12V system costs $147.

Example 3. Another commercially available solar tracking product is Sunflower3 made by Wikoda, Inc. (10). The Sunflower heliostat mirror continuously tracks the sun and reflects sunlight to a fixed spot. Throughout the day, it adjusts the sunlight to the required spot, such as to the lens in FIG. 1 so that this incident sunlight can go through the lens to the focal point into the insulated HIST as described in earlier section.

I claim:

1. A method of storing solar heat, comprising of
directing the solar rays from a mirror to a lens into an insulated heat storage tank and absorbing the concentrated rays from the lens at the focal point by heat storing materials; and • directing the solar rays from a parabolic mirror or magnifying glass into an insulated heat storage tank and absorbing the concentrated rays at the focal point by heat storing materials.

2. The method as defined in claim 1, wherein the lens can be convex or Fresnel lens.

3. The method as defined in claim 1, the directed solar rays pass through a quartz window and the concentrated rays are focused at the focal point inside an insulated heat storage tank.

4. The method as defined in claim 3, the concentrated solar rays are absorbed and stored inside an insulated heat storage tank.

5. The insulated heat storage tank as defined in claim 4, a high temperature resistant ceramic fiber blanket is used to insulate the storage tank for withstanding temperature over 1800 F.

6. The method as defined in claim 4, the absorbing materials in an insulated heat storage tank are capable of storing solar heat for a long time.

7. The materials as defined in claim 6, absorbing materials can be sand, stone, bricks, concrete, marble, steel, iron.

8. The materials as defined in claim 7, can be reused from recycled scrap and are inexpensive.

9. The method as defined in claim 4, the stored solar heat can be transferred to the surrounding area using heat conducting materials such as scrap aluminum, and copper.

10. The materials as defined in claim 9, can be in the form of plates, rods or filings.

11. The method as defined in claim 6, the stored heat can be extracted by circulating room air and gets heated.

12. The method as defined in claim 11, the hot air then passes through an airduct to the home.

13. The method as defined in claim 1, wherein the generation of solar heat may be insufficient in an overcast, rainy or snow day.

14. The method as defined in claim 13, the insufficient heat generation can be compensated by using a backup electrical heating system.

15. The method as defined in claim 14, the backup electrical heating system consists of an electrical resistance heating assembly.

16. The method as defined in claim 15, the electrical resistance heating assembly consists of a resistance heating coil placed inside a quartz tube.

17. The method as defined in claim 16, the heating coil can be made of nichrome wire.

18. The method as defined in claim 15, the resistance heating assembly is connected to an electrical outlet.

19. The method as defined in claim 15, the resistance heating assembly can be also be connected to a solar powered photovoltaic (PV) system.

20. The method as defined in claim 19, the PV system consists of solar panels, inverter, electrical and mechanical hardware.

21. The method as defined in claim 20, the PV system is connected to a solar power generated electrical outlet.

22. The method as defined in claims 18 and 21, the resistance heating assembly when connected to an electrical outlet, it generates heat to a desired temperature set by a thermostat.

23. The method as defined in claim 22, the backup generated heat can be extracted by circulating room air and gets heated.

24. The method as defined in claim 23, the heated air passes through an air duct to the home.

25. The method as defined in claim 1, more stored solar heat can be generated by directing solar rays in more than one side of the heat storing tank using similar set up.

26. The method as defined in claim 25, lens, parabolic mirror, shutter and quartz window can be further protected from atmospheric conditions by using an enclosure to prevent wind, rain, snow, dust like atmospheric changes.
